(19) United States
(12) Patent Application Publication
(10) Pub. No.: US 2007/0195216 A1
(43) Pub. Date: Aug. 23, 2007

(54) Liquid crystal display panel

(75) Inventors: Seok-Je Seong, Gyeonggi-do (KR); Jin-Suk Park, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/707,309

(22) Filed: Feb. 16, 2007

(30) Foreign Application Priority Data
Feb. 20, 2006 (KR) 2006-16053

(51) Int. Cl. G02F 1/1335; G02F 1/136

(52) U.S. Cl. 349/44; 349/114

(57) ABSTRACT

A liquid crystal display panel includes a lower substrate, an organic layer, a pixel electrode, a first light-blocking pattern, an upper substrate, a common electrode, and a liquid crystal layer. The lower substrate includes pixel areas having a switching element disposed therein. An organic layer is disposed on the switching element. The pixel electrode disposed on the organic layer is electrically connected to a drain electrode of the switching element and includes transparent pixel electrode portions and a connecting part electrically connecting the transparent pixel electrode portions to each other. The first light-blocking pattern is disposed under the connecting part. The common electrode is disposed on the upper substrate corresponding to each of the pixel electrode portions and includes opening patterns having a plurality of recesses. Thus, an electric connection between the pixel electrodes maintains and corrosion of the pixel electrode is prevented, so that an image display quality improves.

### CROSS-REFERENCE TO RELATED APPLICATIONS

This application claims priority to Korean Patent Application No. 2006-16053 filed on Feb. 20, 2006, the contents of which are herein incorporated by reference in their entirety.

### BACKGROUND OF THE INVENTION

1. Field of the Invention

The present invention relates to a liquid crystal display panel. More particularly, the present invention relates to a liquid crystal display panel capable of improving a viewing angle and image display quality.

2. Description of the Related Art

A liquid crystal display (LCD) apparatus applies an electric field to a liquid crystal material and controls the intensity of the electric field, thereby displaying an image by controlling the amount of light passing through the liquid crystal material. The liquid crystal material has an anisotropic dielectric constant and is disposed between an array substrate including a thin film transistor and a color filter substrate.

Because of the anisotropic optical transmittance of the liquid crystal, the quality of the image displayed by the LCD apparatus differs according to the direction in which light is transmitted. Therefore, in a conventional LCD apparatus, a good quality image is obtained only within a predetermined viewing angle. When the LCD apparatus is used as a monitor for a desktop computer system, the range of viewing angle is over 90 degrees. In general, the viewing angle is defined as the angle at which the contrast ratio of an image is more than 10:1. The contrast ratio is the brightness difference between a bright spot and a dark spot in the display screen. The contrast ratio increases when the LCD apparatus displays darker colors or when the LCD apparatus has more uniform brightness.

In order to widen the view angel, the LCD apparatus may employ, for example, a multi-domain vertical alignment (MVA) mode, a patterned vertical alignment (PVA) mode, or an in-plane switching (IPS) mode.

In the PVA mode, a pixel electrode is divided into a plurality of areas, so that when a voltage is applied, a multi-alignment structure is obtained through distortion of the electric field. When the area between pixel electrodes is not restored after the orientation of liquid crystal is disturbed by externally applied pressure, image display quality is adversely affected.

The LCD apparatus is a light device that does not emit light, so that light input is required. The LCD apparatus may be classified as a reflective type, a transmissive type, or a reflective-transmissive type.

The reflective-transmissive type LCD apparatus includes an LCD panel displaying an image using both internal light, from a backlight assembly and external light. The LCD panel includes a plurality of pixels, each of which includes a transmissive area displaying an image using the internal light and a reflective area displaying an image using the external light.

When a stepped portion exists between the transmissive area and the reflective area, a crack may be formed in the pixel electrode at the stepped portion. As a result, corrosion occurs at the boundary, thereby damaging display image quality.

### SUMMARY OF THE INVENTION

Example embodiment of the present invention provides a liquid crystal display panel capable of preventing the defect and improving a display quality. In example embodiments of the present invention, a liquid crystal display panel includes a lower substrate, an organic layer, a pixel electrode, a first light-blocking pattern, an upper substrate, a common electrode, and a liquid crystal layer. The lower substrate includes a plurality of pixel areas and a switching element located in each of the pixel areas. An organic layer is disposed on the switching element and a pixel electrode is disposed on the organic layer in each of the pixel areas. The pixel electrode is electrically connected to a drain electrode of the switching element and includes a plurality of transparent portions and a connecting part electrically connecting the transparent pixel electrode portions to each other.

A first light-blocking pattern is disposed under the part connecting the transparent electrode portions to each other. The upper substrate includes a display area corresponding to the pixel areas and a peripheral area surrounding the display area. A common electrode is located on the upper substrate corresponding to each of the pixel electrode portions and includes opening patterns having a plurality of recesses. A liquid crystal layer is disposed between the pixel electrode and the common electrode.

Each of the pixel areas includes a transmissive area and a reflective area, and each of the pixel electrode portions includes a reflective electrode and a transparent electrode. Each of the pixel electrode portions includes rounded corners. A phase difference layer is disposed on at least one of the reflective electrode and the transparent electrode. The reflective electrode is disposed on the switching element. The transparent electrode is disposed in the reflective area and the transmissive area, and the reflective electrode is disposed on the transparent electrode in the reflective area, and a boundary of the reflective electrode is extended further than a boundary of the transparent electrode so that the reflective electrode is partially overlapped by the transparent electrode.

The reflective electrode is extended from the reflective area to the transmissive area, and includes a connecting part disposed on a connecting portion connecting the transmissive area to the reflective area so that the connecting part electrically connects the reflective electrode to the transparent electrode.

In another example embodiment of the present invention, a liquid crystal display panel further includes a second light-blocking pattern disposed adjacent to the first light-blocking pattern and disposed between the pixel electrode parts. The second light-blocking pattern includes a third light-blocking pattern extended toward the first light-blocking pattern under the connecting part of the pixel electrode along the rounded edges of the pixel electrode, and a boundary between the second light-blocking pattern and the third light-blocking pattern is overlapped with the boundary of the pixel electrode.

The organic layer is extended under the second and third light-blocking patterns, and a boundary of the organic layer is disposed between the boundary of the pixel electrode and the boundary of the light-blocking pattern.

Thus, an electric connection between the pixel electrodes maintains and corrosion of the pixel electrode is prevented, so that an image display quality improves.

### BRIEF DESCRIPTION OF THE DRAWINGS

The above and other advantages of the present invention will become readily apparent by reference to the following detailed description when considered in conjunction with the accompanying drawings, in which:

FIG. 1 is a plan view illustrating a liquid crystal display panel in accordance with one embodiment of the present invention;

FIG. 2 is a plan view illustrating a gate electrode, a gate line, a light-blocking pattern and a storage electrode of FIG. 1;

FIG. 3 is a plan view illustrating a source electrode, a data line and a drain electrode of FIG. 1;

FIG. 4 is a plan view illustrating a thin film transistor, a gate line, a data line and a storage electrode of FIG. 1;

FIG. 5 is a plan view illustrating the LCD panel of FIG. 1 on which an organic insulation layer is disposed;

FIG. 6 is a plan view illustrating the LCD panel on which the pixel electrode of FIG. 1 is disposed;

FIG. 7 is a cross-sectional view taken along a line I-I′ of FIG. 1;

FIG. 8 is a cross-sectional view taken along a line II-II′ of FIG. 1;

FIG. 9 is a cross-sectional view taken along a line III-III′ of FIG. 1; and

FIG. 10 is a cross-sectional view taken along a line IV-IV′ of FIG. 1.

### DESCRIPTION OF THE EMBODIMENTS

In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

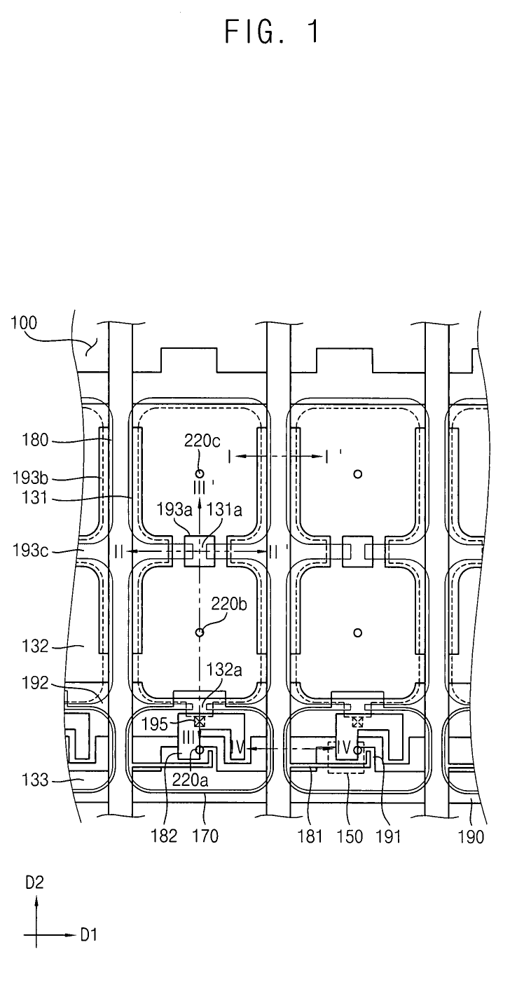

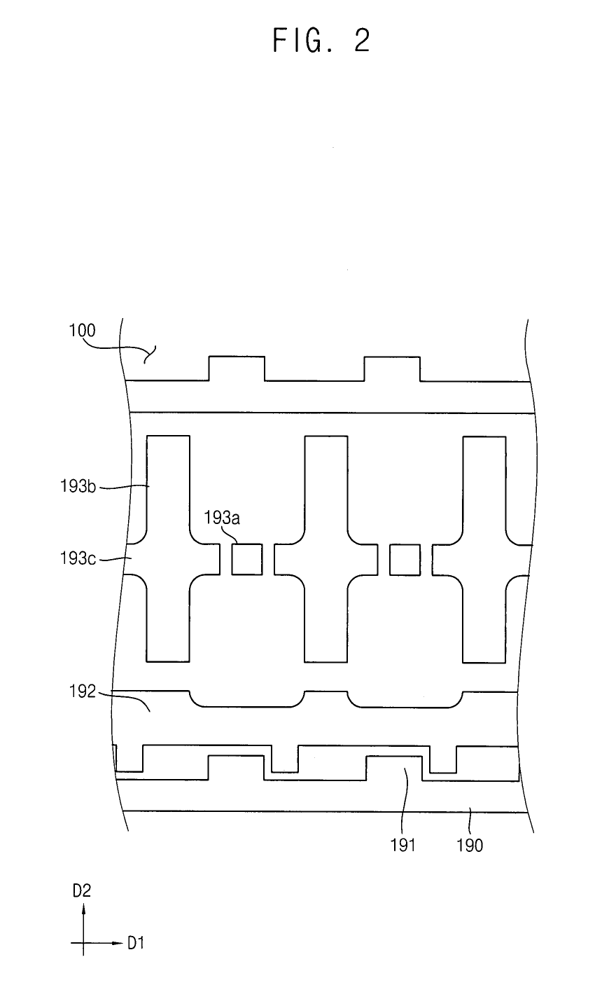

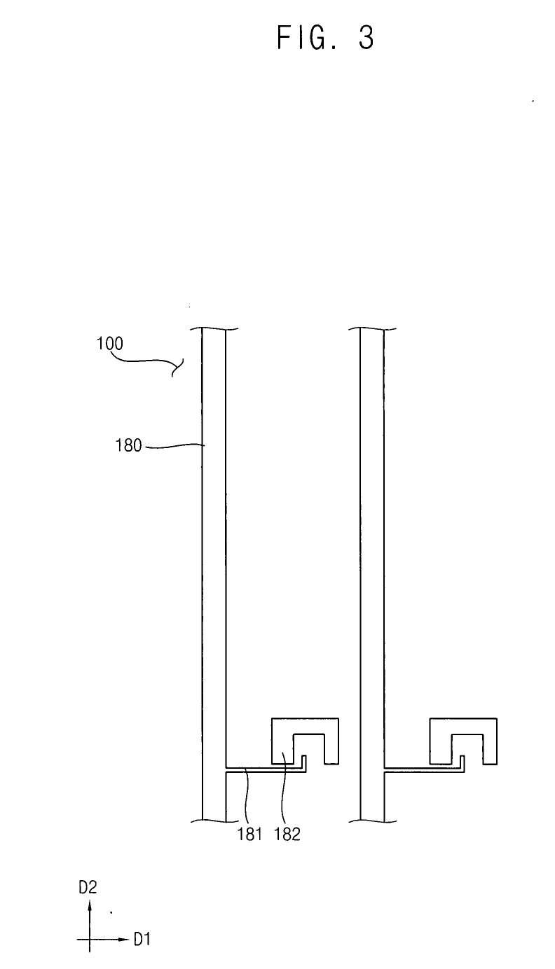

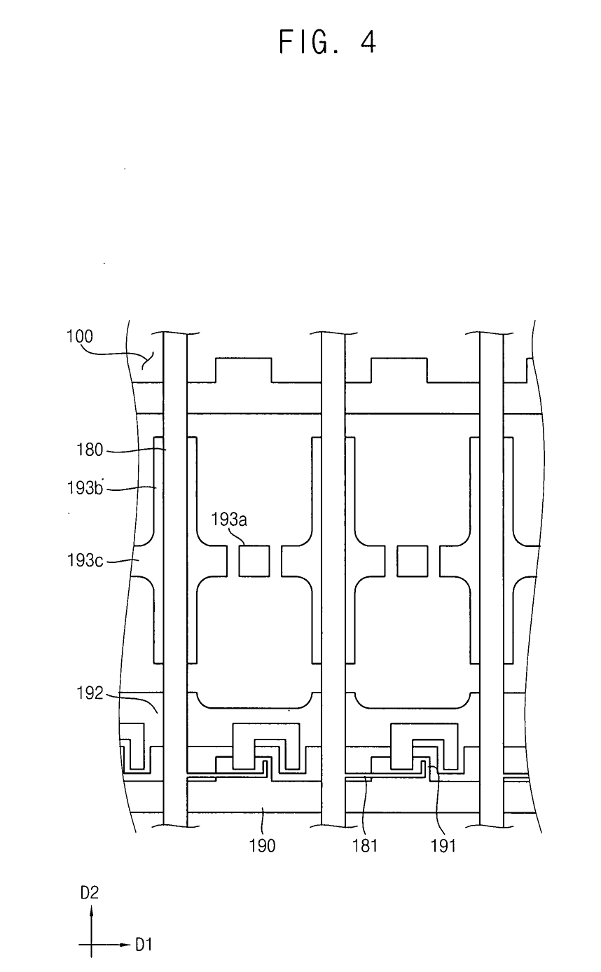

FIG. 1 is a plan view illustrating a liquid crystal display panel in accordance with one embodiment of the present invention. FIG. 2 is a plan view illustrating a gate electrode, a gate line, a light-blocking pattern, and a storage electrode of FIG. 1. FIG. 3 is a plan view illustrating a source electrode, a data line, and a drain electrode. FIG. 4 is a plan view illustrating a thin film transistor, a gate line, a data line, and a storage electrode of FIG. 1.

Referring to FIGS. 1 to 4, the liquid crystal display panel includes a lower substrate 100, an upper substrate (not shown)(not shown), and a liquid crystal layer (not shown).The lower substrate 100 includes a switching element 150, a gate line 190, a gate electrode 191, a data line 180, a storage electrode 192, a first light-blocking pattern 193a, a second light-blocking pattern 193b, a third light-blocking pattern 193c, a source electrode 181, a drain electrode 182, a pixel electrode 130 and a reflective electrode 170. For example, the switching element may include a thin film transistor (TFT). The lower substrate 100 may further include a phase compensation layer.

The upper substrate (not shown) includes a color filter 210, a common electrode 220, a black matrix (not shown), and a spacer (not shown). The liquid crystal layer (not shown) is disposed between the upper substrate (not shown) and the lower substrate 100.

The lower substrate 100 (best seen in FIG. 8), includes a pixel area displaying an image and a light-blocking area 144 blocking light. The pixel area may be formed as a rectangular shape extended in a longitudinal direction of the data line 180. The pixel electrode 130 is disposed in the pixel area.

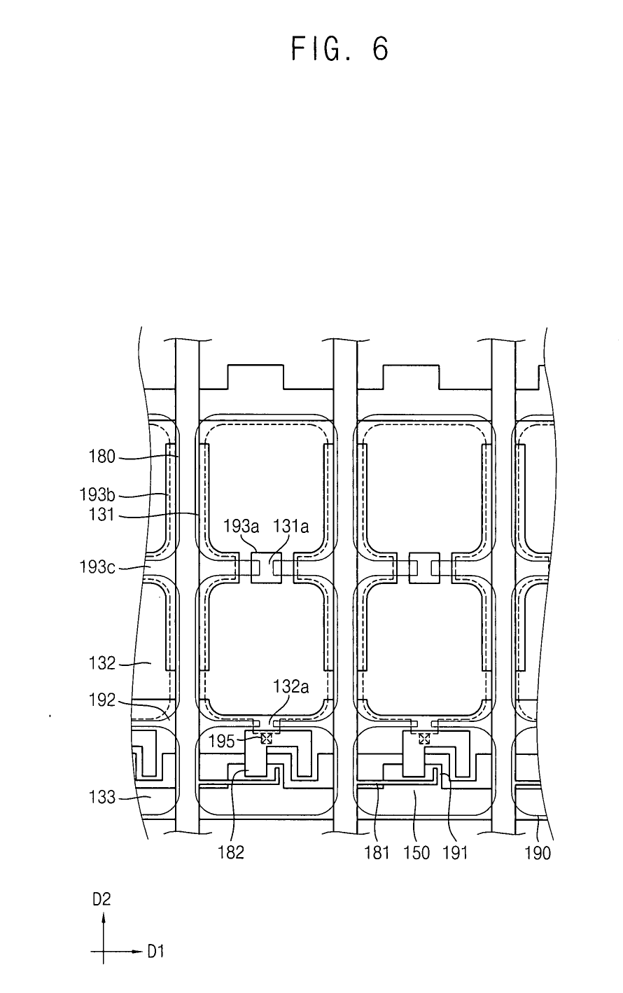

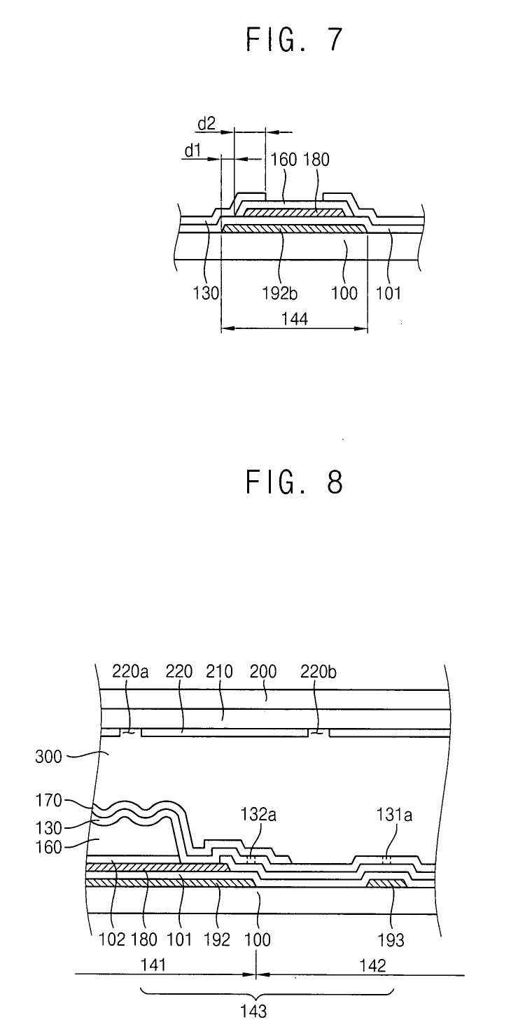

The pixel electrode 130 is electrically connected to the switching element 150 through a contact hole 195, FIG. 6. For example, the pixel electrode 130 (FIG. 7), is electrically connected to the drain electrode 182 of the thin film transistor TFT. The pixel electrode 130 may include a transparent conductive material, for example, indium tin oxide (ITO), indium zinc oxide (IZO), zinc oxide (ZO), and so on. As shown in FIG. 8, pixel area includes a reflective area 141 and a transmissive area 142. Reflective area 141 and transmissive area 142 will be discussed later.

The upper substrate (not shown) and the lower substrate 100 include a transparent glass material such as alkali-free glass. When alkali glass is used, alkali ion is eluted into the liquid crystal cells lowering the specific resistance of the liquid crystal and changing the display characteristics. Also, the adhesion between the sealant and the glass is adversely affected and an operation of the switching element is affected.

The upper substrate (not shown) and the lower substrate 100 may include triacetyl cellulose (TAC), polycarbonate (PC), polyether sulfone (PES), polyethylene terephthalate (PET), polyethylene naphthalate (PEN), polyvinyl alcohol (PVA), polymethyl methacrylate (PMMA), cyclo-olefin polymer (COP) and so on.

The upper substrate (not shown) and the lower substrate 100 may be optically isotropic.

Referring to FIGS. 2 and 3, the gate line 190 is extended in a first direction D1 on the lower substrate 100. The data line 180 is extended in a second direction D2 that is substantially perpendicular to the first direction D1 on the lower substrate 100. Data line 180 crosses gate line 190, and is insulated from gate line 190. Pixel area is defined by the area of crossing of gate line 190 and data line 180.

The switching element 150 includes the gate electrode 191, the source electrode 181, and the drain electrode 182. For example, the thin film transistor TFT may include the gate electrode 191, the source electrode 181, and the drain electrode 182. The TFT is disposed in the pixel area. The drain electrode 182 and the source electrode 181 are spaced apart from each other, and the drain electrode 182 is electrically connected to the pixel electrode 130 through the contact hole 195. Thereby, the TFT is switching-operated in response to a gate signal applied from the gate line 190 and a data signal applied from the data line 180, and the data signal is outputted to the pixel electrode 130.

The storage electrode 192 is simultaneously formed with the gate line 190. The storage electrode 192 is formed on the lower substrate 100, and maintains the voltage difference between the common electrode 220 and the reflective electrode 170 and the voltage difference between the common electrode 220 and the pixel electrode 130.

A gate insulation layer 101 is disposed on the lower substrate 100 including the gate electrode 191, and electrically insulates the gate electrode 191 from the source electrode 181 and the drain electrode 182. The gate insulation layer 101 includes silicon nitride (SiNx), silicon oxide (SiOx) and so on.

A passivation layer 102 is disposed on the lower substrate 100 including the thin film transistor 150, and includes the contact hole 195 partially exposing a part of the drain electrode 182. The passivation layer 102 includes silicon nitride (SiNx), silicon oxide (SiOx) and so on.

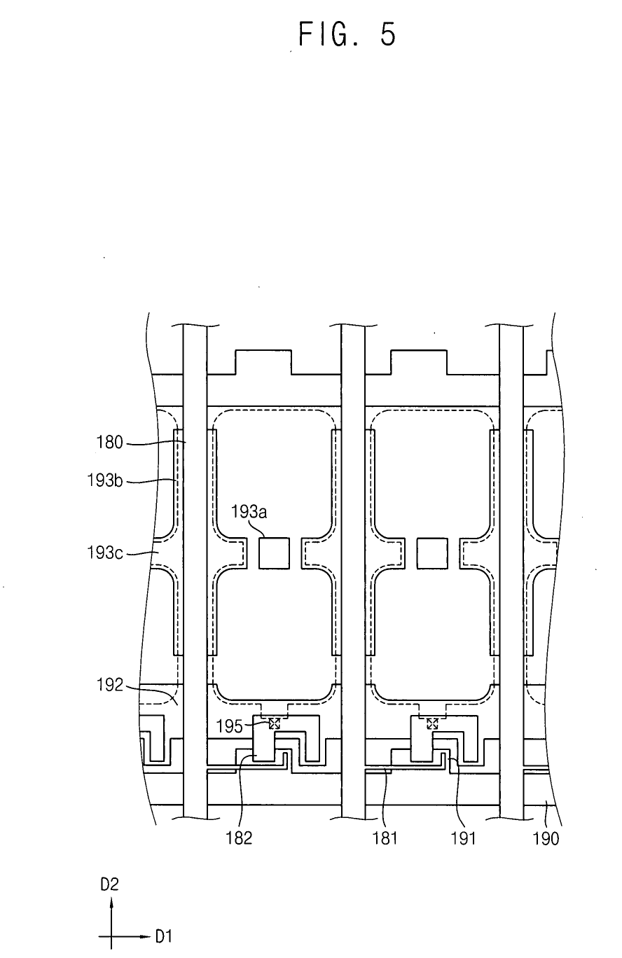

FIG. 5 is a plan view illustrating the LCD panel of FIG. 1 on which an organic insulation layer is disposed. FIG. 6 is a plan view illustrating the LCD panel on which the pixel electrode of FIG. 1 is disposed.

Referring to FIGS. 5 and 6, the switching element 195 is formed on the lower substrate 100, and the passivation layer 102 and an organic insulation layer 160 are disposed on the lower substrate 100, in sequence.

As shown in FIG. 8, in order to make a wavy, uneven surface on organic insulation layer 160, a photo mask having opaque patterns formed on transparent materials corresponding to an embossing is disposed on the organic insulation layer 160, and an exposure process and a developing process are preceded. Thereby, the unevenness is formed on the surface of the organic insulation layer 160.

As shown in FIG. 5, organic insulation layer 160 includes a contact hole 195. Moreover, the organic insulation layer 160 is not disposed in transmissive area 142 of the pixel area. The disposition of the organic insulation layer 160 will be further discussed later.

The pixel area includes the reflective area 141 and the transmissive area 142. As shown in FIG. 8, pixel electrode 130 is disposed in the pixel area. As can be seen in FIG. 6, the pixel electrode 130 includes a first transparent pixel electrode part 131, a second transparent pixel electrode part 132 and a third transparent pixel electrode part 133. The pixel 130 may further include a plurality of a transparent pixel electrode connecting parts 131a and 132a.

Each of the transparent pixel electrode parts 131, 132, and 133 is electrically connected to the other by the transparent pixel electrode connecting parts 131a and 132a. As best seen in FIG. 8, the pixel electrode 130 is disposed on the lower substrate 100. The pixel electrode 130 is disposed within the pixel area, and is disposed on the passivation layer 102 and the organic insulation layer 160.

The first transparent pixel electrode part 131, the second transparent pixel electrode part 132 and the third transparent pixel electrode part 133 are formed adjacent to each other within the pixel area. The first transparent pixel electrode connecting part 131a is disposed between the first transparent electrode part 131 and the second transparent pixel electrode part 132, and electrically connects the first transparent pixel electrode part 131 to the second transparent pixel electrode part 132. The second transparent pixel electrode connecting part 132a is disposed between the second transparent pixel electrode part 132 and the third transparent pixel electrode part 133, and electrically connects the second transparent pixel electrode part 132 to the third transparent pixel electrode part 133.

As best seen in FIG. 6, each of the first transparent pixel electrode part 131, the second transparent pixel electrode part 132 and the third transparent pixel electrode part 133 has a square shape having a rounded corner.

A part of the third transparent pixel electrode part 133 is disposed in the contact hole, and is electrically connected to the drain electrode 182 of the thin film transistor 150. The first transparent pixel electrode part 131, the second transparent pixel electrode part 132 and the third transparent pixel electrode part 133 may be formed as a polygonal shape or a circular shape.

As best seen in FIGS. 6 and 8, the reflective electrode 170 is disposed in the reflective area 141. The reflective area 141 is disposed on the switching element 150. A method of disposing the reflective electrode 170 disposed in the reflective area 141 includes depositing a high reflectivity metal such as aluminum (Al), silver (Ag), or aluminum-neodymium (AlNd) on the organic insulation layer 160 and patterning the deposited metal to a predetermined pixel shape to form the reflective electrode 170 in only the reflective area 141. The reflective electrode 170 has substantially the same shape as the surface of the organic insulation layer 160. A plurality of convex lenses is formed in an area corresponding to relatively high areas, and a plurality of concave lenses is formed in an area corresponding to relatively low areas.

The reflective electrode 170 includes conductive material, is disposed on the third transparent pixel electrode part 133, and is electrically connected to the pixel electrode 130. The third transparent pixel electrode part 133 may not be disposed in the reflective area 141. For example, only the transparent pixel electrode part may be disposed in the transmissive area 142, and only the reflective electrode part may be disposed in the reflective area 141. In order to electrically connect the reflective electrode part to the transparent electrode part, the reflective electrode part and the transparent electrode part may be overlap or may contact each other. The reflective electrode 170 may be extended to an upper portion of the second transparent electrode connecting part 132a. An extension part of the reflective electrode may overlap a predetermined distance along a boundary of the second transparent pixel electrode connecting part.

FIG. 7 is a cross-sectional view taken along a line I-I′ of FIG. 1.

Referring to FIG. 7, the structure of the pixel areas 143 concerning the light-blocking area 144 between the pixel areas 143 is illustrated in FIG. 7. Edges of the pixel electrode 130 are illustrated in FIG. 7. The light-blocking area 144 includes a second light-blocking pattern 193b, a gate insulation layer 101, a data line 180, an organic insulation layer 160 and a pixel electrode 130.

The second light-blocking pattern 193b, the gate insulation layer 101, the data line 180, the organic insulation 160, and the pixel electrode 130 are disposed in the light-blocking area 144, in sequence. The width of the second light-blocking pattern 193b is greater than the organic insulation layer 160. The pixel electrode 130 may be in a portion of the light-blocking area 144. The light-blocking area may further include a passivation layer.

Boundaries of the second light-blocking pattern 193b, the organic insulation layer 160, and the pixel electrode 130 are spaced apart from each other. The boundary of the second light-blocking pattern 193b is closer to the pixel area than the organic insulation layer 160. A distance d2 between the boundary of the second light-blocking pattern 193b and the boundary of the organic insulation layer 160 may be between about 1.5 to 2.0 μm. Thereby, a surface uniformity of the pixel electrode 130 disposed in the light-blocking are 144 may be improved.

The pixel electrode 130 is extended in a direction toward the light-blocking area 144. The boundary of the pixel electrode 130 adjacent to the light-blocking area 144 is overlapped with the boundary of the organic insulation layer 160 adjacent to the pixel area. A distance d1 from the boundary of the pixel electrode 130 to the boundary of the organic insulation layer 160 may be between about 2.0 to 2.5 μm. Thereby, the surface uniformity of the pixel electrode 130 is increased, and erosion of the pixel electrode 130 is decreased.

FIG. 8 is a cross-sectional view taken along a line II-II′ of FIG. 1.

The upper substrate 200 includes the color filter 210 and the common electrode 220. The common electrode 220 includes opening parts 220a and 220b.

The color filter 210 is formed in the display area 143 of the upper substrate 200, and transmits light having a predetermined wave-length. The color filter 210 includes a red color filter part, a green color filter part, and a blue color filter part. The color filter 210 includes a photopolymerization initiator, a monomer, a binder, a pigment, a dispersing agent, a solvent, a photo-resist, etc. The color filter 210 may be disposed on the lower substrate 100 or on the passivation layer 102.

The common electrode 220 is formed at a front surface of the upper substrate 100 including the black matrix and the color filter 210. The common electrode 220 includes a transparent conductive material such as indium tin oxide (ITO), indium zinc oxide (IZO), zinc oxide (ZO), etc.

The common electrode 220 may further include a phase difference layer (not shown). The phase difference layer changes the phase of incident linear polarized light to circular polarized light or elliptical polarized light. Also, the phase of incident light may be changed by about 1/10λ to ½λ. Λ represents the wave-length of the light. For example, the phase of the incident light may be changed by about ¼λ, and the longitudinal axis of the incident light may be about 45 degrees with respect to the X-Y plane. When the light passes through the phase difference layer, the speed of light in parallel with the phase changing axis is different from the speed of light substantially perpendicular to the phase changing axis. Thus, the phase of the light is changed by about ¼λ.

The common electrode 220 includes opening patterns 220a, 220b, and 220c. The common electrode 220 is partially removed to form the opening patterns 220a, 220b, and 220c. The common electrode 220 includes three opening patterns 220a, 220b, and 220c. Each of the opening patterns 220a, 220b, and 220c correspond to a center each of the first transparent pixel electrode part 131, the second transparent pixel electrode part 132 and the third transparent pixel electrode part 133.

When a voltage difference is applied between the transparent electrode 20 220 and the common electrode 220, the electric field formed between the pixel electrode 130 and the common electrode 220 is distorted in an area adjacent to the opening patterns 220a, 220b and 220c, an area between the first transparent pixel electrode part 131 and the second transparent pixel electrode part 132, and an area between the second transparent pixel electrode part 132 and the third transparent pixel electrode part 133. Multi domains are formed in the liquid crystal layer 300 by the distorted electric field, so that the viewing angle improves.

The lower substrate 100 includes a storage electrode 192, a first light-blocking pattern 193a, a gate insulation layer 101, a drain electrode 182, a passivation layer 102, an organic insulation layer 160, a pixel electrode 130, and a reflective electrode 170. The lower substrate 100 may further include a phase difference layer. The function of the phase difference layer is the same as the phase difference layer mentioned above.

Referring to FIGS. 1 and 8, the first light-blocking pattern 193a is disposed under the first transparent pixel electrode connecting part 131a. The first light-blocking pattern 193a overlaps the entire boundary of the first transparent pixel electrode connecting part 131a. In order to increase an aperture ratio, the length of the overlapped area may be minimized.

An organic insulation layer is disposed in the pixel area except the transmissive area 142. The organic insulation layer 160 may include an embossing pattern to form different heights. The organic insulation layer 160 is disposed in the reflective area. The organic insulation layer 160 may not be disposed in a linking area 160a electrically connecting the contact hole 195 to the third transparent pixel electrode connecting part 132a. The organic insulation layer 160 may be disposed only on an area of the reflective area except the contact hole 195, the second transparent pixel electrode connecting part 132a and the linking area 160a. Thereby, the stepped portion on the contact hole 195 is decreased so that the surface uniformity of the organic insulation layer 160 is increased. Moreover, a stepped portion at the second transparent pixel electrode connecting part 132a may be reduced.

The reflective electrode 170 is disposed on the pixel electrode 130 of the reflective area 144. The reflective electrode 170 is overlapped with the boundary of the third transparent pixel electrode part 133. A portion of the reflective electrode 170 is extended toward the second transparent pixel electrode connecting part 132a. The portion of the reflective electrode 170 may be overlapped with the boundary of the second transparent pixel electrode connecting part 132a.

The extended portion may be extended toward an upper portion of a connecting part connecting the second transparent pixel electrode connecting part 132a to the second transparent pixel electrode 132. Thereby, when the second transparent pixel electrode 132 and the third transparent pixel electrode 133 are electrically disconnected to each other, an electric connection between the pixel electrode 130 and the reflective electrode 170 maintains.

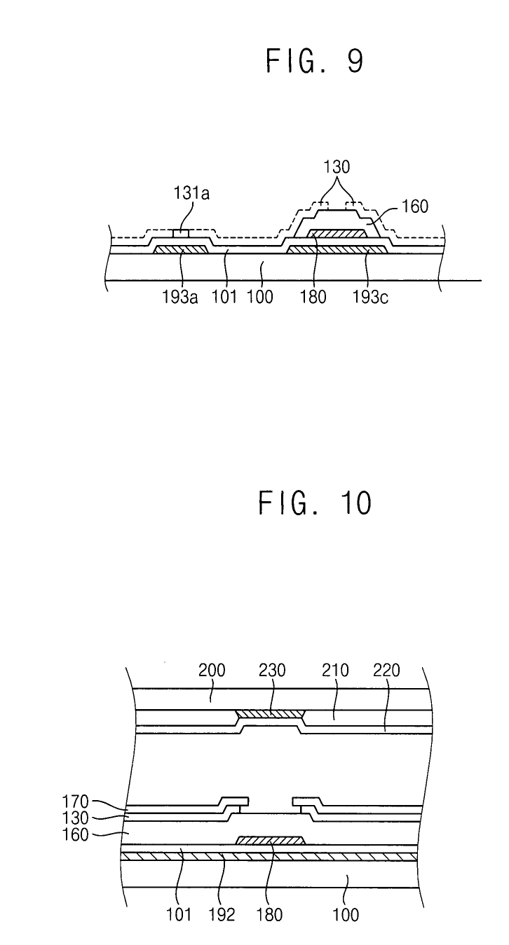

FIG. 9 is a cross-sectional view taken along a line III-III′ of FIG. 1.

Referring to FIG. 9, the first light-blocking pattern 193a is disposed under the first transparent pixel electrode connecting part 131a. The second light-blocking pattern 193b includes the third light-blocking pattern 193c extended toward the first transparent pixel electrode connecting part 131a. The second light-blocking pattern 193b may be electrically connected to the storage electrode 192.

The third light-blocking pattern 193c is overlapped with a corner portion of the pixel electrode 130. The third light-blocking pattern 193c is overlapped along a boundary of the pixel electrode 130 having rounded corners. The boundary of the organic insulation layer 160 is disposed between the boundary of the pixel electrode 130 and the boundary of the third light-blocking pattern 193c. A distance d3 from the boundary of the third light-blocking pattern 193c to the boundary of the organic insulation layer 160 may be between about 1.5 to 2.0 μm.

A shape of the second light blocking pattern 193b and the third light-blocking pattern 193c may be substantially a cross shape. The second light-blocking pattern 193b is extended in the second direction D2 along the data line 180, and the third light-blocking pattern 193c is extended in the first direction D1 that is substantially perpendicular to the second direction.

FIG. 10 is a cross-sectional view taken along a line IV-IV′ of FIG. 1.

Referring to FIG. 10, the upper substrate 200 includes the color filter 210, the common electrode 220, and a black matrix 230. An opaque material is deposited on the upper substrate 200. A portion of the opaque material is removed, thereby forming the black matrix 230. The opaque material and the photo-resist material may be coated on the upper substrate 200 and the black matrix 230 may be formed by a photo process. The photo process includes an exposure process and the development process.

A mixture including a red pigment and photo-resist is coated on the upper substrate 200 where the black matrix 230 is formed. The coated mixture is exposed and developed by a mask to form the red color filter part. The green color filter part and the blue color filter part are formed on the upper substrate 200 where the black matrix 230 and the red color filter part are formed. A transparent conductive material is deposited on the black matrix 230 and the color filter 210.

A storage electrode 192, a gate insulation layer 101, a data line 180, an organic insulation layer 160, a pixel electrode 130 and a reflective electrode 170 that are disposed on the lower substrate 100, are discussed above, and the repetitive explanation will be omitted. The boundary of the reflective electrode 170 is protruded further than the boundary of the pixel electrode 130.

According to the present invention, the pixel electrode is formed as a square shape with rounded edges, and the boundary of the pixel electrode is overlapped with the organic insulation layer and the light-blocking pattern. Thus, corrosion of the pixel electrode is prevented, and an image display quality improves.

The organic layer is not disposed and the reflective electrode is disposed in the connecting portion between the contact hole and the pixel electrode, so that the electric connection of the pixel electrode maintains and the image display quality improves.

By now, those skilled in this art will appreciate that many modifications, substitutions and variations can be made in and to the materials, apparatus, configurations, and methods of the display panels of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. A liquid crystal display panel comprising:
a lower substrate including a plurality of pixel areas and a switching element disposed in each of the pixel areas;
an organic layer disposed on the switching element;
a pixel electrode disposed on the organic layer in each of the pixel areas and electrically connected to a drain electrode of the switching element, the pixel electrode including a plurality of pixel electrode portions and a connecting part electrically connecting the pixel electrode portions to each other;
a first light-blocking pattern disposed under the connecting part;
an upper substrate including a display area corresponding to the pixel areas and a peripheral area surrounding the display area;
a common electrode disposed on the upper substrate corresponding to each of the pixel electrode portions, the common electrode including opening patterns having a plurality of recesses; and
a liquid crystal layer disposed between the pixel electrode and the common electrode.

2. The display panel of claim 1, wherein each of the pixel electrode portions has rounded corners.

3. The display panel of claim 2, wherein each of the pixel areas comprises a transmissive area and a reflective area, and each of the pixel electrode portions comprises a reflective electrode and a transparent electrode.

4. The display panel of claim 3, further comprising a phase difference layer disposed on at least one of the reflective electrode and the transparent electrode.

5. The display panel of claim 3, wherein the reflective electrode is disposed on the switching element.

6. The display panel of claim 5, wherein the thickness of the organic layer in an area where the reflective electrode is disposed is different from the thickness of the organic layer in an area where the transparent electrode is disposed.

7. The display panel of claim 5, wherein the transparent electrode is disposed in the reflective area and the transmissive area,
the reflective electrode is disposed on the transparent electrode in the reflective area, and
a boundary of the reflective electrode is extended further than the boundary of the transparent electrode so that the reflective electrode partially overlaps the transparent electrode.

8. The display panel of claim 7, wherein the reflective electrode is extended from the reflective area to the transmissive area, and comprises a connecting part disposed on a connecting portion connecting the transmissive area to the reflective area to electrically connect the reflective electrode to the transparent electrode.

9. The display panel of claim 8, wherein the connecting part is disposed only on the connecting portion of the transmissive area and the reflective area.

10. The display panel of claim 2, further comprising a second light-blocking pattern disposed adjacent to the first light-blocking pattern and disposed between the pixel electrode parts.

11. The display panel of claim 10, wherein the second light-blocking pattern comprises a third light-blocking pattern extended toward the first light-blocking pattern under the connecting part of the pixel electrode along the rounded edges of the pixel electrode, and
a boundary between the second light-blocking pattern and the third light-blocking pattern is overlapped with the boundary of the pixel electrode.

12. The display panel of claim 11, wherein the organic layer is extended under the second and third light-blocking patterns, and a boundary of the organic layer is disposed between the boundary of the pixel electrode and the boundary of the light-blocking pattern.

13. The display panel of claim 12, wherein the boundary of the organic layer is overlapped with the pixel electrode by about 2.0 to about 2.5 μm.

14. The display panel of claim 12, wherein the boundary between the second and third light-blocking patterns is longer than the boundary of the organic layer by about 1.5 to about 2.0 μm.

15. The display panel of claim 12, wherein transparent electrode is disposed in the reflective area and the transmissive area,
the reflective electrode is disposed on the transparent electrode disposed in the reflective area, and
the boundary of the reflective is extended further than the boundary of the transparent electrode.

16. The display panel of claim 15, wherein the reflective electrode is extended from the reflective area to the transmissive area, and comprises a connecting part disposed on a connecting portion connecting the transmissive area to the reflective area to electrically connect the reflective electrode to the transparent electrode.

17. The display panel of claim 16, wherein the connecting part is disposed only on the connecting portion of the reflective electrode and the transparent electrode.

18. The display panel of claim 16, wherein the organic layer exposes the connecting part.
